(19) United States
(12) Patent Application Publication
(10) Pub. No.: US 2025/0056486 A1
(43) Pub. Date: Feb. 13, 2025

(54) ENHANCED PRECISION RANGING FOR WI-FI NETWORKS

(71) Applicant: Intel Corporation, Santa Clara, CA (US)

(72) Inventors: Qinghua LI, San Ramon, CA (US); Jonathan SEGEV, Sunnyvale, CA (US); Xintian LIN, Palo Alto, CA (US); Shlomi VITURI, Tel Aviv (IL); Robert STACEY, Portland, OR (US); Carlos CORDEIRO, Camas, WA (US)

(73) Assignee: Intel Corporation, Santa Clara, CA (US)

(21) Appl. No.: 18/818,419

(22) Filed: Aug. 28, 2024

Related U.S. Application Data
(60) Provisional application No. 63/535,284, filed on Aug. 29, 2023.

(51) Int. Cl. H04W 64/00; H04W 24/10; H04W 56/00

(52) U.S. Cl. CPC H04W 64/00; H04W 24/10; H04W 56/0015

(57) ABSTRACT

This disclosure describes systems, methods, and devices related to enhanced ranging. A device may initiate a ranging sequence by transmitting an NDPA frame followed by an I2R NDP frame. The device may receive a corresponding R2I NDP frame and an R2I LMR from a responding station. The device may repeat the ranging sequence for two or more iterations to collect multiple data sets. The device may process the R2I NDP frame and the R2I LMR to generate continuous ToA and ToD measurements for each iteration.

### CROSS-REFERENCE TO RELATED APPLICATION(S)

This application claims the benefit of U.S. Provisional Application No. 63/535,284, filed Aug. 29, 2023, the disclosure of which is incorporated herein by reference as if set forth in full.

### TECHNICAL FIELD

This disclosure generally relates to systems and methods for wireless communications and, more particularly, to enhanced precision ranging for Wi-Fi networks.

### BACKGROUND

Modern Wi-Fi networks are converging on the need for improved accuracy in positioning and navigation, making precise timing and distance measurements more critical than ever. With the advent of sophisticated processing circuitry, such precision can be achieved by averaging inputs from multiple data sources and finely adjusting temporal synchronization. Consequently, there is a need to integrate these technological advances to enhance the precision of wireless communication systems while maintaining alignment with existing protocols.

### BRIEF DESCRIPTION OF THE DRAWINGS

FIG. 1 is a network diagram illustrating an example network environment for enhanced ranging, in accordance with one or more example embodiments of the present disclosure.

FIGS. 2-4, 5A, 5B, 6, 7, 8A, 8B, 9A, 9B, 9C, 10A, and 10B depict illustrative schematic diagrams for enhanced ranging, in accordance with one or more example embodiments of the present disclosure.

FIG. 11 illustrates a flow diagram of a process for an illustrative enhanced ranging system, in accordance with one or more example embodiments of the present disclosure.

FIG. 12 illustrates a functional diagram of an exemplary communication station that may be suitable for use as a user device, in accordance with one or more example embodiments of the present disclosure.

FIG. 13 illustrates a block diagram of an example machine upon which any of one or more techniques (e.g., methods) may be performed, in accordance with one or more example embodiments of the present disclosure.

FIG. 14 is a block diagram of a radio architecture in accordance with some examples.

FIG. 15 illustrates an example front-end module circuitry for use in the radio architecture of FIG. 14, in accordance with one or more example embodiments of the present disclosure.

FIG. 16 illustrates an example radio IC circuitry for use in the radio architecture of FIG. 14, in accordance with one or more example embodiments of the present disclosure.

FIG. 17 illustrates an example baseband processing circuitry for use in the radio architecture of FIG. 14, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

It should be understood that very high throughput (VHT) null data packet (NDP) Sounding-based 802.11az (“11az”) protocol is referred to as VHTz and high efficiency (HE) null data packet (NDP) Sounding-based 802.11az protocol is referred to as HEz. Basically, VHTz is based on the 802.11ac NDP and is a single user sequence; HEz is based on 802.11ax NDP and 802.11az NDP and it is a multiuser sequence.

802.11bk task group aims for high accuracy Wi-Fi ranging using 320 MHz wide channels. This bold step is expected to significantly enhance location tracking capabilities, enabling services such as indoor navigation with greater precision than ever before.

Ranging in the context of wireless networks is a method used to determine the distance between two communicating devices, typically referred to as stations. It involves measuring the time it takes for a signal to travel from the initiating station to the responding station and back again (Time of Flight), with techniques such as double-sided ranging enhancing accuracy by accounting for any discrepancies in the devices' internal clocks.

One factor that may impede taking full advantage of this wider bandwidth is the difference between local oscillators or clocks. Previous generations REVmc and 11az fine timing measurement (FTM) use single sided FTM, the clock difference in the conventional single sided ranging of 802.11az degrades the performance such that Wi-Fi ranging is uncompetitive to Ultra-Wideband (UWB) ranging. Therefore, rectifying these oscillator discrepancies is pivotal for exploiting the full potential of the 320 MHz channels for advanced applications. A scheme is proposed to improve the ranging accuracy for Wi-Fi. REVmc refers to a maintenance update of the IEEE 802.11 standards, addressing enhancements and corrections post the initial release of the standards.

However, this technique is limited because it is unable to compensate for the remainder of the interval (the TOF). Identifying and addressing this gap could lead to a breakthrough in distance measurement technologies within Wi-Fi systems. Another reason why this technique is limited is because it cannot compensate for the estimation frequency error of the received signal. Improving frequency error compensation is essential for the next generation of high-precision wireless applications, from augmented reality to smart manufacturing.

Example embodiments of the present disclosure relate to systems, methods, and devices for enhanced precision ranging for Wi-Fi networks, such as high accuracy ranging for 802.11bk. Developing these systems further may allow for Wi-Fi to surpass current ranging limitations and unlock new possibilities for consumer and industrial use.

In wireless systems, ranging involves measuring the time it takes for a signal to travel from one device to another and back again, allowing for the calculation of the distance between them based on the known speed of the signal (the speed of light, in the case of radio waves). However, this measurement relies heavily on the synchronization of the internal clocks of each device (Initiator STA and Responder STA). If the devices' clocks are not synchronized, which is often the case, the time measurement will be inaccurate, leading to errors in the calculated distance—this is known as clock offset. With single-sided ranging, the time of flight (TOF) of the signal is measured usually in one direction or from one perspective, which relies on one device's clock. This can lead to significant errors if the device's clock is not perfectly calibrated with the absolute time or with the clock on the other device. Double-sided ranging improves this by taking measurements from both devices. For example, Device A sends a signal to Device B, which then sends a signal back. Both devices measure the time intervals, and by combining these measurements, it is possible to correct for any differences between the two devices' clocks. This effectively means that any clock error is measured and compensated for by considering the time measurement from both sides of the communication, hence the term “double-sided”. This bilateral approach to measuring time reduces the chance that clock errors will affect the resulting distance measurement, thus enabling higher accuracy in determining the location of a device. By mitigating clock errors, double-sided ranging could pave the way for more applications where precise location tracking is essential, ranging from automated guided vehicles in industrial settings that require pinpoint location accuracy to operate safely, to augmented reality games that rely on the user's exact position in a room for an immersive experience.

In one embodiment, an enhanced ranging system may propose ranging measurement schemes for Wi-Fi, e.g., 802.11bk. Double-sided ranging is employed to mitigate the effect of clock errors. Frame exchange protocols are provided. This innovative approach could mark a significant moment in wireless technology, offering a viable alternative to heftier infrastructure investments in precision tracking. The enhanced ranging system may make Wi-Fi ranging accuracy comparable to UWB and competitive in the indoor ranging and proximity detection market. Achieving such accuracy could spark a paradigm shift in how location-based services are integrated into everyday technologies.

The above descriptions are for the purpose of illustration and are not meant to be limiting. Numerous other examples, configurations, processes, algorithms, etc., may exist, some of which are described in greater detail below. Example embodiments will now be described with reference to the accompanying figures.

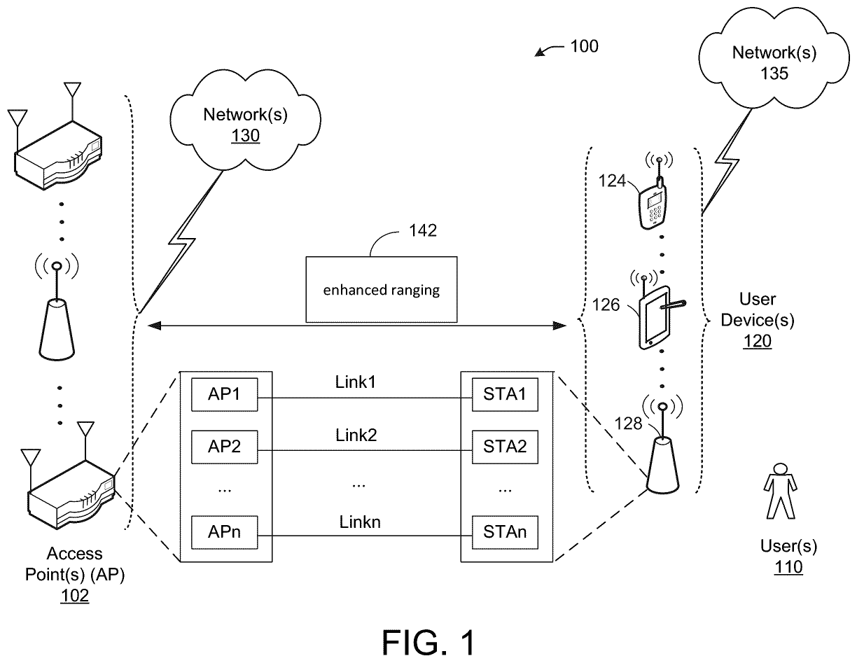

FIG. 1 is a network diagram illustrating an example network environment of enhanced ranging, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

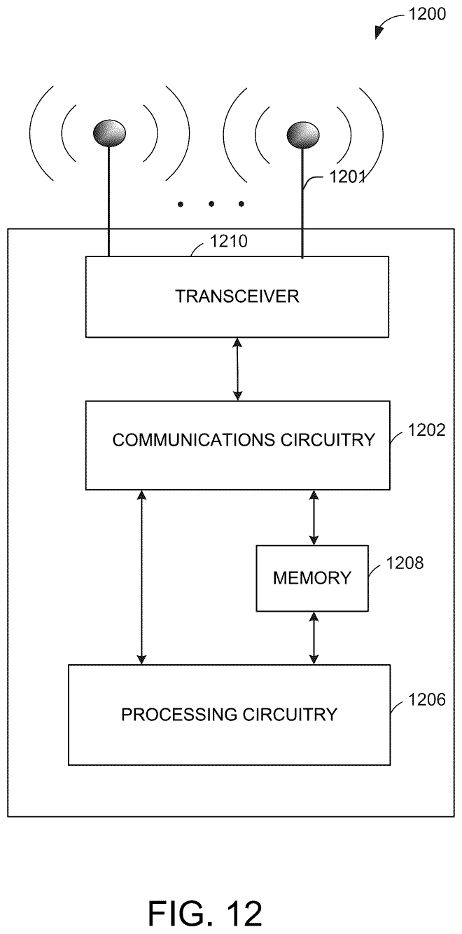

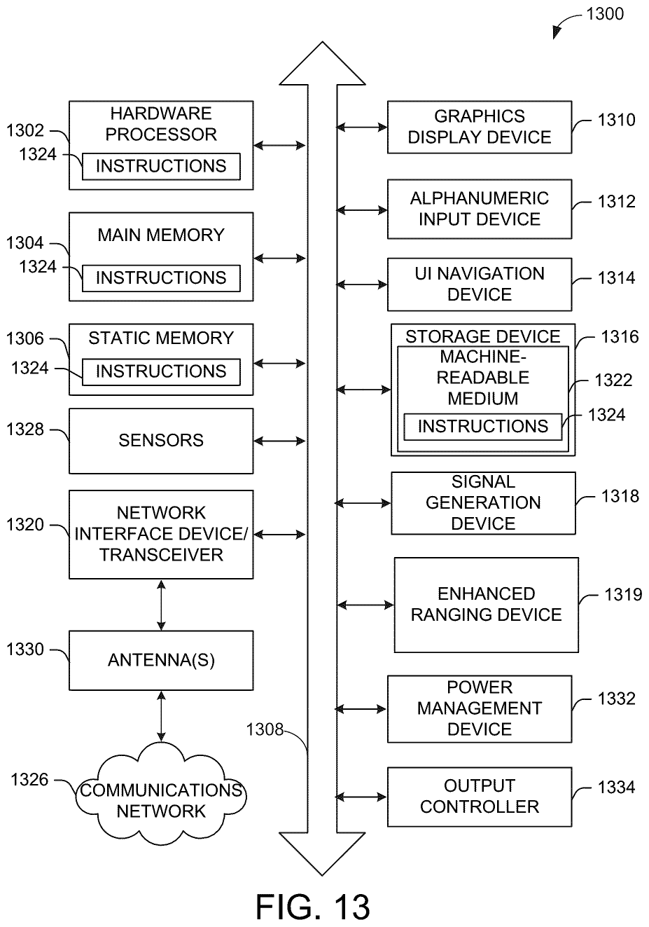

In some embodiments, the user devices 120 and the AP 102 may include one or more computer systems similar to that of the functional diagram of FIG. 12 and/or the example machine/system of FIG. 13.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QOS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad, 802.11ay, 802.11az). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, AP 102 may facilitate enhanced ranging 142 with one or more user devices 120.

It is understood that the above descriptions are for purposes of illustration and are not meant to be limiting.

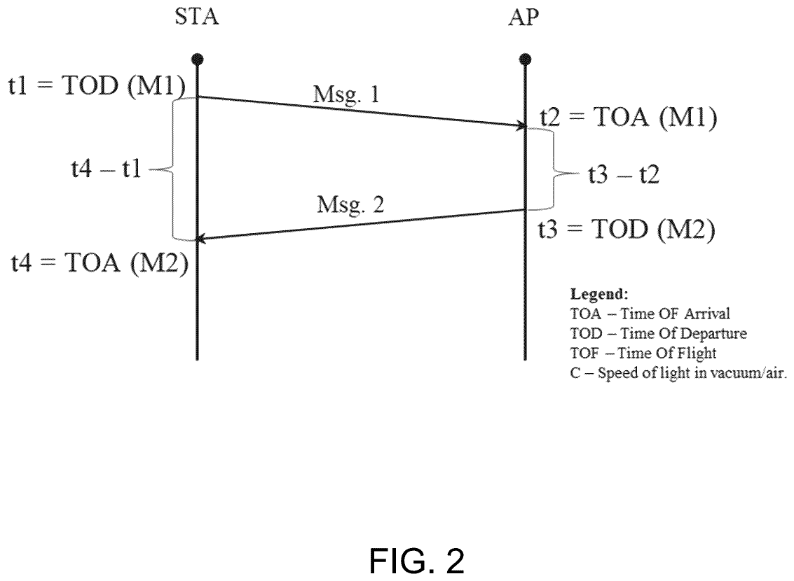

FIGS. 2-10 depict illustrative schematic diagrams for enhanced ranging, in accordance with one or more example embodiments of the present disclosure.

Referring to FIG. 2, there is shown a single sided range measurement.

REVmc and 802.11az FTM use single sided ranging which means both the ISTA (Initiating STA) and RSTA measures. A high-level description of the measurement sequence is shown in FIG. 2. REVmc refers to an amendment to the existing 802.11 standards that concerns maintenance and various minor corrections. It can involve updates to earlier specifications for wireless technology to improve performance, security, or interoperability. In the context of ranging, these updates may include measures to fine-tune how devices calculate distances between each other using Wi-Fi signals.

802.11az suffers from the clock difference between receivers, each local clock uses the local oscillator to measure the interval t4-t1 and t3-t2 locally and possibly to adjust one local counter to the other by adjusting the clock from one of the sides to the other, by removing the drift of the shared time t3-t2. This adjustment process promises more consistent and reliable communication between devices that are dependent on synchronized timing for accurate ranging.

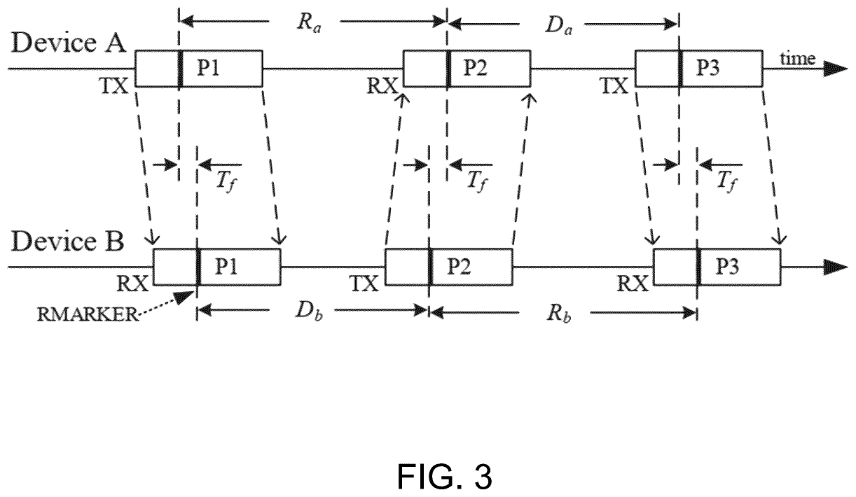

In UWB, a double-sided two-way ranging scheme, which is shown in FIG. 3, is employed to mitigate the ranging error due to clock differences between the two ranging devices. The derivation of the time of flight (ToF) between the two devices, T_{f}, is recapped below.

In FIG. 3, device A transmits a message, P1, to device B. Device B receives this message a short time later and after a time, D_{b}, it transmits a message, P2, back to device A. Message P2 arrives at device A at a time Ra after it transmitted message P1. These then have the following relationship:

$${R}_{a} = 2 {T}_{f} + {D}_{b} \qquad ( D \text{.1} )$$

So,

$${T}_{f} = ( {R}_{a} - {D}_{b} ) / 2 \qquad ( D \text{.2} )$$

In practice, the times are measured by real clocks in A and B, which will run independently, either faster or slower than an ideal clock, synchronized to their local reference frequency generator which can be assumed to be a constant frequency over the duration of the ranging exchange. Assume the clocks A and B run respectively at kₐ and k_{b} times the frequency of an ideal, true, clock. Any time measurements will be multiplied by these constants, kₐ or k_{b}. Denoting the actual time estimates for Rₐ and Dₐ as \hat{R}ₐ and \hat{D}ₐ, respectively, and similarly \hat{R}_{b} and \hat{D}_{b} as the estimates of R_{b} and D_{b}. Then, since Rₐ is measured at A by A's clock:

$${\hat{R}}_{a} = {k}_{a} {R}_{a} \qquad ( D \text{.3} )$$

And, similarly,

$${\hat{D}}_{a} = {k}_{a} {D}_{a} \qquad ( D \text{.4} )$$

$${\hat{R}}_{b} = {k}_{b} {R}_{b} \qquad ( D \text{.5} )$$

$${\hat{D}}_{b} = {k}_{b} {D}_{b} \qquad ( D \text{.6} )$$

Finally, after some manipulations, the ToF estimate of the UWB scheme is given by

$$\frac{{\hat{R}}_{a} {\hat{R}}_{b} - {\hat{D}}_{a} {\hat{D}}_{b}}{{R}_{a} + {\hat{D}}_{a}} = 2 {T}_{f} {k}_{b} \approx 2 {T}_{f} , \qquad ( D \text{.19} )$$

$$\frac{{\hat{R}}_{a} {\hat{R}}_{b} - {\hat{D}}_{a} {\hat{D}}_{b}}{{R}_{b} + {\hat{D}}_{b}} = 2 {T}_{f} {k}_{a} \approx 2 {T}_{f} . \qquad ( D \text{.20} )$$

From the recap, it can be seen that the estimate is an approximation because kₐ and k_{b} are unknown and approximated as 1 in the scheme.

In this disclosure, an enhanced ranging system may facilitate enhancements to 802.11az. First, it is proposed to have a clock estimation requirement and clock error feedback. Second, using the idea in the UWB scheme, it is desired to design ranging schemes that are compatible with the existing 802.11az ranging schemes.

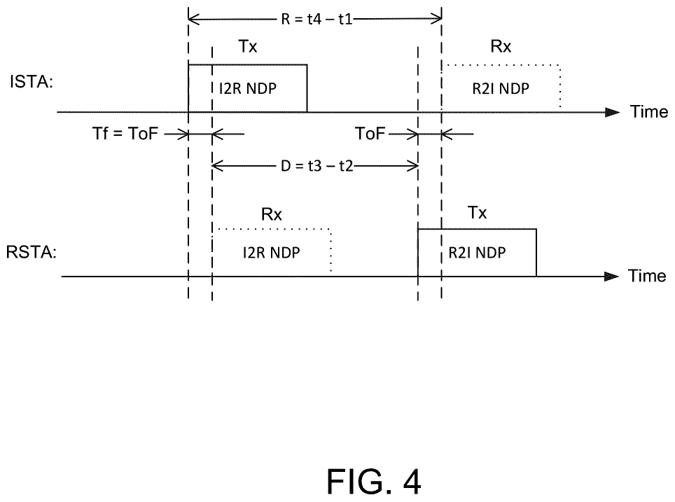

In the conventional 802.11az scheme as shown in FIG. 4, when the clocks of the ISTA and the RSTA are synchronized, indicated by k_{b} equaling kₐ and with an absence of noise distortion, the error in the Time of Flight (ToF) measurement falls to the clock's inherent error level. In terms of figures, this error level might be as minuscule as 40 parts per million (ppm), or 0.004%. At a measured distance of 10 meters, the resulting error could be less than 0.4 mm. Consequently, this suggests that achieving high accuracy in distance measurements does not necessarily require double-sided ranging; instead, enhancing the clock offset estimation within the existing framework of 802.11az could suffice.

The terms k_{b} and kₐ in the context of wireless communication protocols, such as 802.11az, typically refer to the parameters associated with the clock frequencies or timing mechanisms of two communicating devices—the initiating station (ISTA) and the responding station (RSTA), respectively. These parameters are critical as they relate to the precision with which these devices can measure time, an essential factor in calculating distances through the Time of Flight (ToF) methodology.

k_{b} denotes a variable related to the clock of the responding station (RSTA), potentially encompassing the frequency, phase, or timing offset specifics of the device's internal clock mechanism. Similarly, kₐ is the equivalent variable for the initiating station (ISTA). Both k_{b} and kₐ are instrumental in the process of synchronizing time-related measurements across the wireless network for distance calculations.

The ratio k_{b}/kₐ, therefore, becomes a crucial factor in compensating for any variances between the two clocks. If the clocks are perfectly synchronized, k_{b}/kₐ equals 1, implying that there is no discrepancy between ISTA's and RSTA's timing-both are in perfect harmony, which is the ideal state for the most accurate ToF measurements. If this ratio deviates from 1, it indicates a difference in clock settings, which must be accounted for to ensure ranging precision. It is by refining this ratio based on additional measurements and constraints within the network that the system can mitigate the relative error in ToF calculations, thereby optimizing the accuracy of the distance estimation within the parameters of the system's design.

In one or more embodiments, the wireless communication system employs enhanced clock offset estimations to avoid complex ranging methods while maintaining high accuracy. For example, a Wi-Fi-enabled device in a smart home could determine its distance from the central hub with precision enough to support seamless device interactivity and automation.

Another embodiment may capitalize on the precise clock synchronization to facilitate single-sided ranging, simplifying the overall design while being conducive to highly accurate positioning. For example, in robotics or warehouse automation, robots could efficiently calculate their distances from fixed stations to navigate working environments accurately, eliminating any need for additional positioning hardware.

Furthermore, there could be an embodiment where the system's enhanced clock offset estimation expands its application to critical areas like elderly care, where exact location tracking within a residence can ensure immediate assistance when required. For instance, the system could localize a fallen individual within less than half a millimeter of the actual position, enabling rapid response without the complexity of a doubled sided ranging system.

First, there is a need to mandate that the clock for carrier frequency and the timing clock for the TOA and TOD shall share the same mother clock so that the estimate of the carrier frequency offset can be used to compensate for the timing clock difference. Mother clock refers to a principal clock source from which other clocks within a system derive their timing.

Second, it should be specified in the standard whether the carrier frequency offset (CFO) should be compensated or corrected for the TOA and TOD values reported in the location measurement report (LMR). It makes more sense not to than to compensate the CFO because this prevents low end devices from giving poor corrections in the ranging operation.

Third, it should be specified in the standard whether a device should change its carrier frequency or clock during the ranging exchange. For example, the RSTA estimated the CFO from the initiator-to-responder (I2R) NDP and then changes the carrier frequency for sending the responder-to-initiator (R2I) NDP. It makes more sense not to change the clock or carrier frequency during ranging exchange.

Several methods to enhance the clock estimation are as follows.

Currently, there is no report of the carrier frequency offset (CFO) between the ISTA and RSTA in the R2I LMR which is the location measurement report sent by the responding STA and received by the initiating STA. Therefore, the initiating STA can only estimate the CFO from the R2I NDP and R2I LMR. This CFO estimation can be enhanced by the CFO report sent by the RSTA. Namely, the ISTA can have two copies of CFO estimates, one from itself and the other from the RSTA. Using two instead of one estimate, e.g., by averaging them, improves the accuracy of CFO estimation such that the ratio of k_{b}/kₐ can be estimated better.

### Repetitions of Sounding Signal:

Repetitions of the sounding signal(s) can be applied to the NDP frame(s), e.g., in FIG. 2. The number of repetitions can be negotiated or exchanged as supported in 802.11az where the repetition is for SNR boosting and attack detection. The receiver can estimate the carrier frequency offset by utilizing the repetitions for correcting the clock difference or carrier frequency difference between the transmitter and receiver.

Currently, there is no requirement specified in 802.11az specification for the clock estimation. For example, the timing clock is used for t2 and t3. It is possible to add the requirement of the clock estimation or the clock compensation. The existing CFO estimation uses the single stream pilots in the long training field (LTF) of the NDP of non-secure mode. The number of pilot subcarriers is number much smaller than the number of active subcarriers in the LTF, e.g., 64 vs. 1928 for 160 MHz. The repetition of LTF enables an improved CFO estimation using all active subcarriers in the LTFs. The 802.11az specification may require improved CFO estimation. Or, the improved CFO estimation may be a capability of a device, which can be indicated.

### Repetitions of Ranging Measurement:

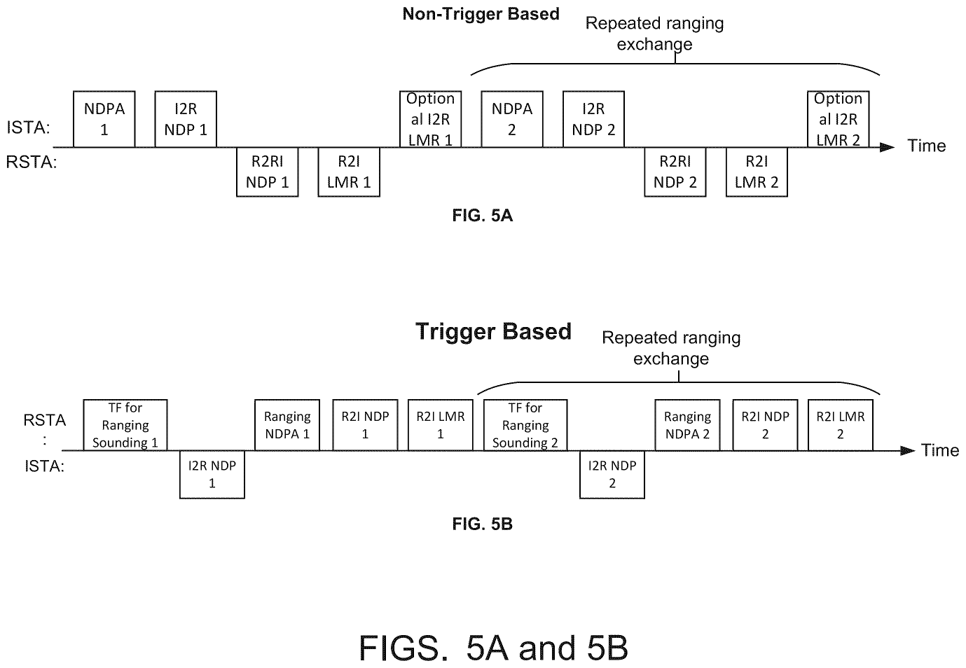

Although a brand-new ranging exchange can be designed for Wi-Fi double sided ranging, it is desirable to maximize the backward compatibility. A backward compatible design is shown in FIG. 5 (FIGS. 5A and 5B). Two or more legacy ranging exchanges are used in a row.

Referring to FIGS. 5A and 5B, there are shown repeated ranging measurements.

The repetition schemes in FIGS. 5A and 5B provide sufficient observations for solving the unknown variables, e.g., ToF and k_{b}/k_{g}. In addition to ToF, the k_{b}/kₐ can be estimated from the additional measurement and two additional constraints. The additional measurement provides another ToF estimate. The two additional constraints are:
The two ToF estimated from the repeated measurements should be equal;
The duration between two ToD of one device should be equal to the duration between two ToA of the other device.

By solving the equations formed by the observations and the constraints, both ToF and k_{b}/kₐ can be obtained. By estimating the k_{b}/kₐ, the relative error of ToF can be reduced to the clock error level, e.g., 40 ppm. For example, for a distance of 10 m, the error can be 0.4 mm.

To enable the schemes in FIGS. 5A and 5B, one device needs:
The ToA and ToD reported from the other should be continuous between the two adjacent measurements;
The clock remains unchanged between the measurements.

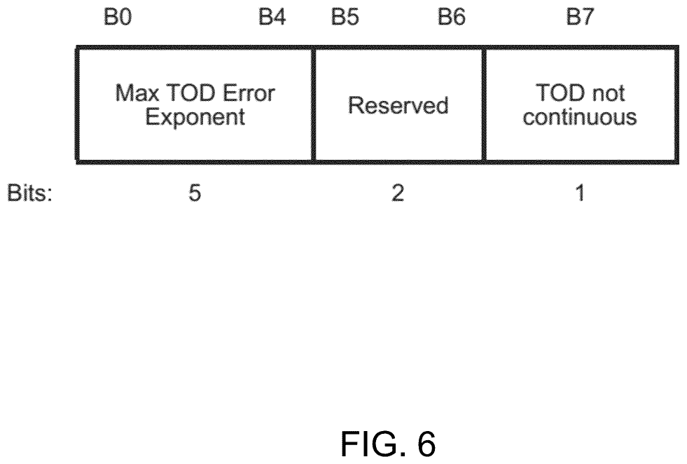

There is a subfield “TOD not continuous” in the field “TOD Error field” in the location measurement report (LMR) as shown in FIG. 6 in IEEE 802.11az standard. This subfield needs to be set to 0 for indicating the continuity of the timing clock, which is used to measure the ToD and ToA.

The proposed solutions above maximize the backward compatibility. For example, the scheme in FIGS. 5A and 5B reuse the existing measurement exchange for enhancing the ranging accuracy at the cost of efficiency.

In the following, new measurement exchange sequences are proposed for enhancing the accuracy without losing the efficiency.

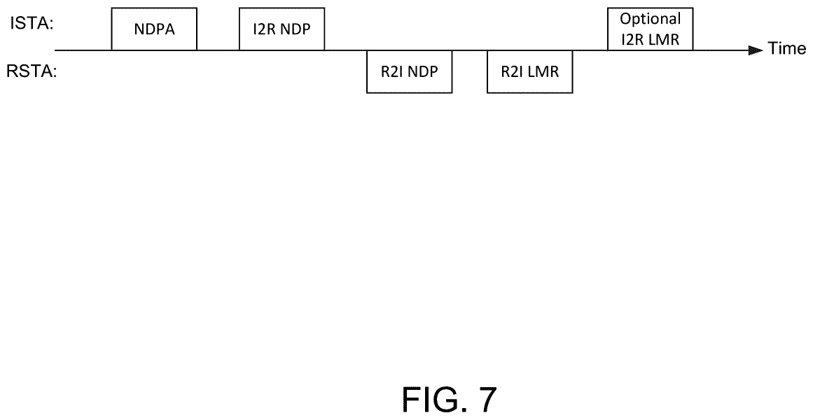

New Measurement Exchange Sequence: the conventional 802.11az ranging scheme for non-trigger-based case is shown in FIG. 7.

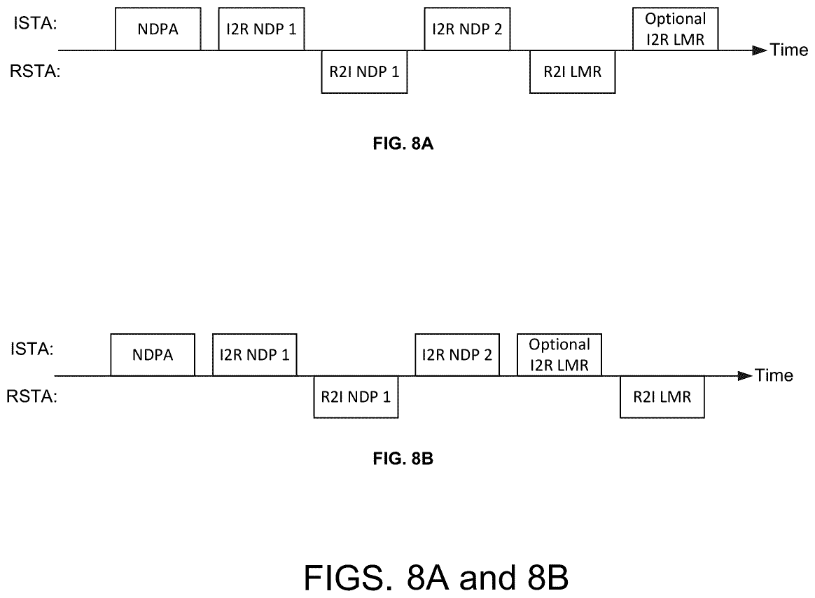

The proposed schemes are shown in FIGS. 8A and 8B. In FIGS. 8A and 8B, one NDP sounding frame from initiating STA (ISTA) to responding STA (RSTA), I2R NDP2, is added after the conventional R2I NDP 1. The ToF of the two schemes in FIGS. 8A and 8B can be derived similarly from the UWB one by replacing Device A and Device B by ISTA and RSTA, respectively in FIG. 3. Different from the conventional 802.11az scheme, the R2I LMR sent by RSTA needs to report two values for the time of arrival (ToA), one for I2R NDP 1 and the other for I2R NDP 2. In FIGS. 8A and 8B, RSTA needs to report the ToA of I2R NDP 2 after SIFS time for immediate feedback mode. In 802.11az, RSTA has the frame R2I NDP between the I2R NDP and R2I LMR. This provides time for RSTA to estimate the ToA of the I2R NDP. Because of the reduced estimation time, the R2I LMR may support three types, 1) immediate feedback of both ToAs, 2) delayed feedback of both ToAs, 3) immediate feedback for the ToA of I2R NDP 1 and delayed feedback for the ToA of I2R NDP 2. For option 3), the immediate feedback provides a rough ToA, and the delayed feedback provides a refined ToA.

Referring to FIG. 8, there is shown a proposed non-trigger-based ranging scheme with three NDP frames.

In FIG. 8B, Optional I2R LMR goes before R2I LMR. This provides RSTA additional time to estimate the ToAs at the cost of more 802.11 specification changes than FIG. 8A.

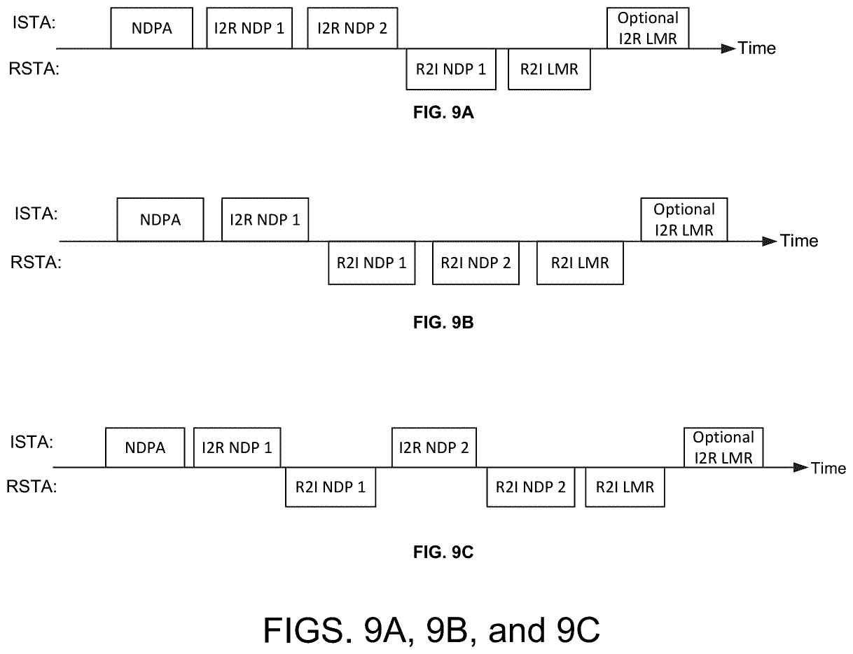

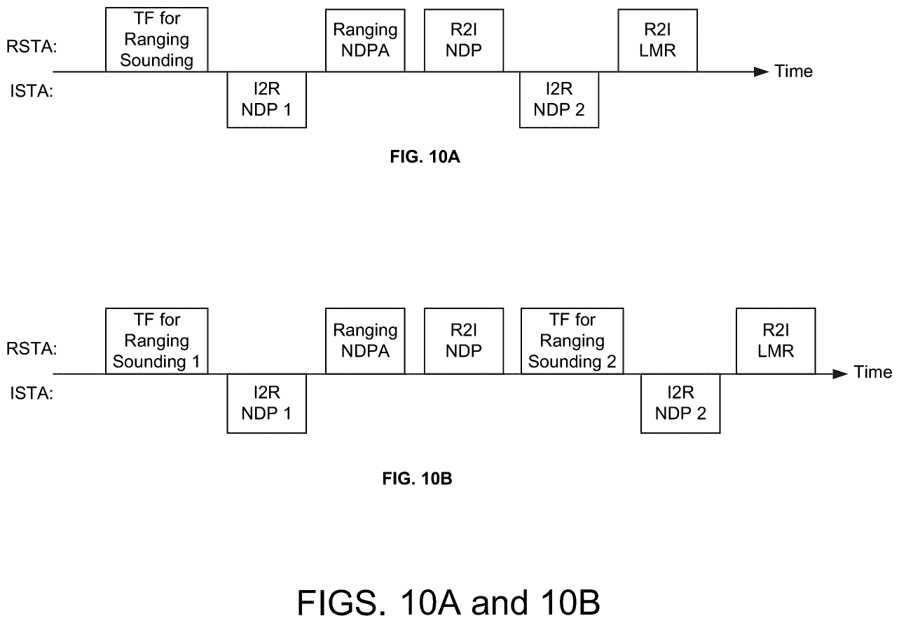

To enable the double-sided ranging in 802.11, either the ISTA or the RSTA needs to sound the channel twice or more, e.g., sending two NDPs. The NDPs from one device can be sent in a row or with another frame in between. Some measurement exchange sequences are proposed in FIGS. 9A-9C and FIGS. 10A-10B for non-trigger-based ranging and trigger-based ranging, respectively.

It is understood that the above descriptions are for the purposes of illustration and are not meant to be limiting.

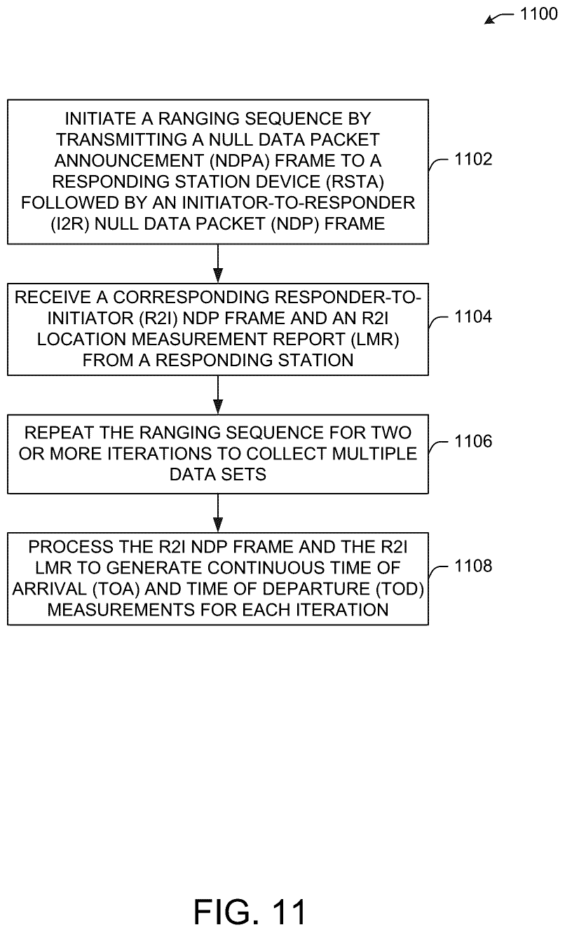

FIG. 11 illustrates a flow diagram of illustrative process 1100 for an enhanced ranging system, in accordance with one or more example embodiments of the present disclosure.

At block 1102, a device (e.g., the user device(s) 120 and/or the AP 102 of FIG. 1 and/or the enhanced ranging device 1319 of FIG. 13) may initiate a ranging sequence by transmitting an NDPA frame followed by an I2R NDP frame.

At block 1104, the device may receive a corresponding R2I NDP frame and an R2I LMR from a responding station.

At block 1106, the device may repeat the ranging sequence for two or more iterations to collect multiple data sets.

At block 1108, the device may process the R2I NDP frame and the R2I LMR to generate continuous ToA and ToD measurements for each iteration.

It is understood that the above descriptions are for the purposes of illustration and are not meant to be limiting.

FIG. 12 shows a functional diagram of an exemplary communication station 1200, in accordance with one or more example embodiments of the present disclosure. In one embodiment, FIG. 12 illustrates a functional block diagram of a communication station that may be suitable for use as an AP 102 (FIG. 1) or a user device 120 (FIG. 1) in accordance with some embodiments. The communication station 1200 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1200 may include communications circuitry 1202 and a transceiver 1210 for transmitting and receiving signals to and from other communication stations using one or more antennas 1201. The communications circuitry 1202 may include circuitry that can operate the physical layer (PHY) communications and/or medium access control (MAC) communications for controlling access to the wireless medium, and/or any other communications layers for transmitting and receiving signals. The communication station 1200 may also include processing circuitry 1206 and memory 1208 arranged to perform the operations described herein. In some embodiments, the communications circuitry 1202 and the processing circuitry 1206 may be configured to perform operations detailed in the above figures, diagrams, and flows.

In accordance with some embodiments, the communications circuitry 1202 may be arranged to contend for a wireless medium and configure frames or packets for communicating over the wireless medium. The communications circuitry 1202 may be arranged to transmit and receive signals. The communications circuitry 1202 may also include circuitry for modulation/demodulation, upconversion/downconversion, filtering, amplification, etc. In some embodiments, the processing circuitry 1206 of the communication station 1200 may include one or more processors. In other embodiments, two or more antennas 1201 may be coupled to the communications circuitry 1202 arranged for sending and receiving signals. The memory 1208 may store information for configuring the processing circuitry 1206 to perform operations for configuring and transmitting message frames and performing the various operations described herein. The memory 1208 may include any type of memory, including non-transitory memory, for storing information in a form readable by a machine (e.g., a computer). For example, the memory 1208 may include a computer-readable storage device, read-only memory (ROM), random-access memory (RAM), magnetic disk storage media, optical storage media, flash-memory devices and other storage devices and media.

In some embodiments, the communication station 1200 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1200 may include one or more antennas 1201. The antennas 1201 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1200 may include one or more of a keyboard, a display, a non-volatile memory port, multiple antennas, a graphics processor, an application processor, speakers, and other mobile device elements. The display may be an LCD screen including a touch screen.

Although the communication station 1200 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1200 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1200 may include one or more processors and may be configured with instructions stored on a computer-readable storage device.

FIG. 13 illustrates a block diagram of an example of a machine 1300 or system upon which any one or more of the techniques (e.g., methodologies) discussed herein may be performed. In other embodiments, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in peer-to-peer (P2P) (or other distributed) network environments. The machine 1300 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1300 may include a hardware processor 1302 (e.g., a central processing unit (CPU), a graphics processing unit (GPU), a hardware processor core, or any combination thereof), a main memory 1304 and a static memory 1306, some or all of which may communicate with each other via an interlink (e.g., bus) 1308. The machine 1300 may further include a power management device 1332, a graphics display device 1310, an alphanumeric input device 1312 (e.g., a keyboard), and a user interface (UI) navigation device 1314 (e.g., a mouse). In an example, the graphics display device 1310, alphanumeric input device 1312, and UI navigation device 1314 may be a touch screen display. The machine 1300 may additionally include a storage device (i.e., drive unit) 1316, a signal generation device 1318 (e.g., a speaker), an enhanced ranging device 1319, a network interface device/transceiver 1320 coupled to antenna(s) 1330, and one or more sensors 1328, such as a global positioning system (GPS) sensor, a compass, an accelerometer, or other sensor. The machine 1300 may include an output controller 1334, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1302 for generation and processing of the baseband signals and for controlling operations of the main memory 1304, the storage device 1316, and/or the enhanced ranging device 1319. The baseband processor may be provided on a single radio card, a single chip, or an integrated circuit (IC).

The storage device 1316 may include a machine readable medium 1322 on which is stored one or more sets of data structures or instructions 1324 (e.g., software) embodying or utilized by any one or more of the techniques or functions described herein. The instructions 1324 may also reside, completely or at least partially, within the main memory 1304, within the static memory 1306, or within the hardware processor 1302 during execution thereof by the machine 1300. In an example, one or any combination of the hardware processor 1302, the main memory 1304, the static memory 1306, or the storage device 1316 may constitute machine-readable media.

The enhanced ranging device 1319 may carry out or perform any of the operations and processes (e.g., process 1100) described and shown above.

It is understood that the above are only a subset of what the enhanced ranging device 1319 may be configured to perform and that other functions included throughout this disclosure may also be performed by the enhanced ranging device 1319.

While the machine-readable medium 1322 is illustrated as a single medium, the term “machine-readable medium” may include a single medium or multiple media (e.g., a centralized or distributed database, and/or associated caches and servers) configured to store the one or more instructions 1324.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1300 and that cause the machine 1300 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1324 may further be transmitted or received over a communications network 1326 using a transmission medium via the network interface device/transceiver 1320 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1320 may include one or more physical jacks (e.g., Ethernet, coaxial, or phone jacks) or one or more antennas to connect to the communications network 1326. In an example, the network interface device/transceiver 1320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1300 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

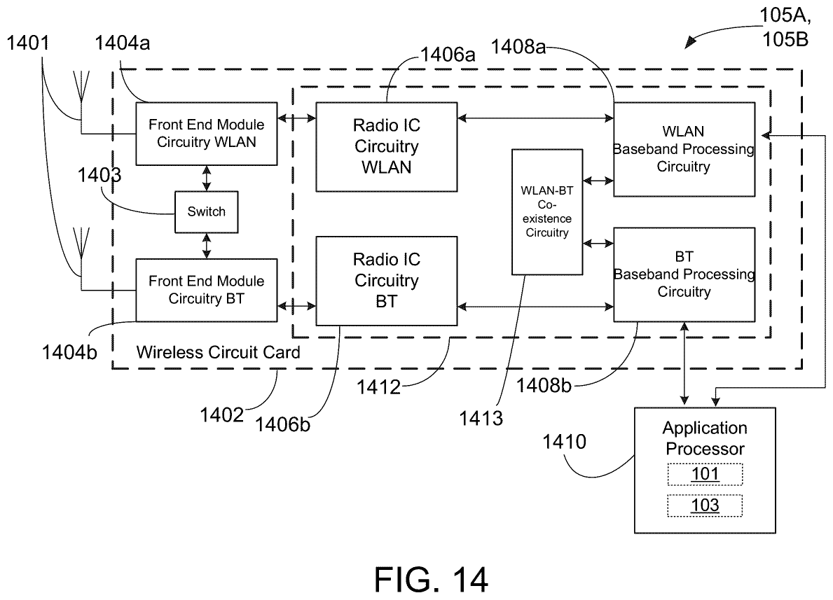

FIG. 14 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1404a-b, radio IC circuitry 1406a-b and baseband processing circuitry 1408a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1404a-b may include a WLAN or Wi-Fi FEM circuitry 1404a and a Bluetooth (BT) FEM circuitry 1404b. The WLAN FEM circuitry 1404a may include a receive signal path comprising circuitry configured to operate on WLAN RF signals received from one or more antennas 1401, to amplify the received signals and to provide the amplified versions of the received signals to the WLAN radio IC circuitry 1406a for further processing. The BT FEM circuitry 1404b may include a receive signal path which may include circuitry configured to operate on BT RF signals received from one or more antennas 1401, to amplify the received signals and to provide the amplified versions of the received signals to the BT radio IC circuitry 1406b for further processing. FEM circuitry 1404a may also include a transmit signal path which may include circuitry configured to amplify WLAN signals provided by the radio IC circuitry 1406a for wireless transmission by one or more of the antennas 1401. In addition, FEM circuitry 1404b may also include a transmit signal path which may include circuitry configured to amplify BT signals provided by the radio IC circuitry 1406b for wireless transmission by the one or more antennas. In the embodiment of FIG. 14, although FEM 1404a and FEM 1404b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1406a-b as shown may include WLAN radio IC circuitry 1406a and BT radio IC circuitry 1406b. The WLAN radio IC circuitry 1406a may include a receive signal path which may include circuitry to down-convert WLAN RF signals received from the FEM circuitry 1404a and provide baseband signals to WLAN baseband processing circuitry 1408a. BT radio IC circuitry 1406b may in turn include a receive signal path which may include circuitry to down-convert BT RF signals received from the FEM circuitry 1404b and provide baseband signals to BT baseband processing circuitry 1408b. WLAN radio IC circuitry 1406a may also include a transmit signal path which may include circuitry to up-convert WLAN baseband signals provided by the WLAN baseband processing circuitry 1408a and provide WLAN RF output signals to the FEM circuitry 1404a for subsequent wireless transmission by the one or more antennas 1401. BT radio IC circuitry 1406b may also include a transmit signal path which may include circuitry to up-convert BT baseband signals provided by the BT baseband processing circuitry 1408b and provide BT RF output signals to the FEM circuitry 1404b for subsequent wireless transmission by the one or more antennas 1401. In the embodiment of FIG. 14, although radio IC circuitries 1406a and 1406b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1408a-b may include a WLAN baseband processing circuitry 1408a and a BT baseband processing circuitry 1408b. The WLAN baseband processing circuitry 1408a may include a memory, such as, for example, a set of RAM arrays in a Fast Fourier Transform or Inverse Fast Fourier Transform block (not shown) of the WLAN baseband processing circuitry 1408a. Each of the WLAN baseband circuitry 1408a and the BT baseband circuitry 1408b may further include one or more processors and control logic to process the signals received from the corresponding WLAN or BT receive signal path of the radio IC circuitry 1406a-b, and to also generate corresponding WLAN or BT baseband signals for the transmit signal path of the radio IC circuitry 1406a-b. Each of the baseband processing circuitries 1408a and 1408b may further include physical layer (PHY) and medium access control layer (MAC) circuitry, and may further interface with a device for generation and processing of the baseband signals and for controlling operations of the radio IC circuitry 1406a-b.

Referring still to FIG. 14, according to the shown embodiment, WLAN-BT coexistence circuitry 1413 may include logic providing an interface between the WLAN baseband circuitry 1408a and the BT baseband circuitry 1408b to enable use cases requiring WLAN and BT coexistence. In addition, a switch 1403 may be provided between the WLAN FEM circuitry 1404a and the BT FEM circuitry 1404b to allow switching between the WLAN and BT radios according to application needs. In addition, although the antennas 1401 are depicted as being respectively connected to the WLAN FEM circuitry 1404a and the BT FEM circuitry 1404b, embodiments include within their scope the sharing of one or more antennas as between the WLAN and BT FEMs, or the provision of more than one antenna connected to each of FEM 1404a or 1404b.

In some embodiments, the front-end module circuitry 1404a-b, the radio IC circuitry 1406a-b, and baseband processing circuitry 1408a-b may be provided on a single radio card, such as wireless radio card 1402. In some other embodiments, the one or more antennas 1401, the FEM circuitry 1404a-b and the radio IC circuitry 1406a-b may be provided on a single radio card. In some other embodiments, the radio IC circuitry 1406a-b and the baseband processing circuitry 1408a-b may be provided on a single chip or integrated circuit (IC), such as IC 1412.

In some embodiments, the wireless radio card 1402 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1408b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHZ, 2.4 GHz, 5 GHZ, and bandwidths of about 2 MHz, 4 MHZ, 5 MHz, 5.5 MHz, 6 MHz, 8 MHz, 10 MHZ, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

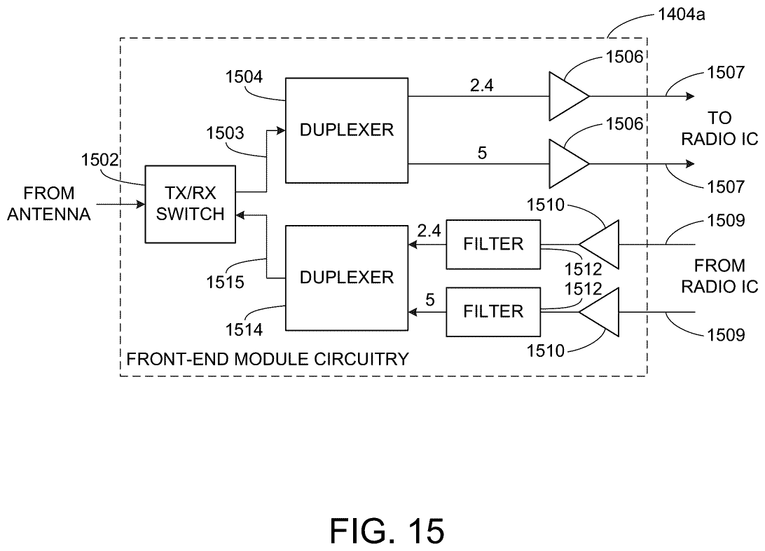

FIG. 15 illustrates WLAN FEM circuitry 1404a in accordance with some embodiments. Although the example of FIG. 15 is described in conjunction with the WLAN FEM circuitry 1404a, the example of FIG. 15 may be described in conjunction with the example BT FEM circuitry 1404b (FIG. 14), although other circuitry configurations may also be suitable.

In some embodiments, the FEM circuitry 1404a may include a TX/RX switch 1502 to switch between transmit mode and receive mode operation. The FEM circuitry 1404a may include a receive signal path and a transmit signal path. The receive signal path of the FEM circuitry 1404a may include a low-noise amplifier (LNA) 1506 to amplify received RF signals 1503 and provide the amplified received RF signals 1507 as an output (e.g., to the radio IC circuitry 1406a-b (FIG. 14)). The transmit signal path of the circuitry 1404a may include a power amplifier (PA) to amplify input RF signals 1509 (e.g., provided by the radio IC circuitry 1406a-b), and one or more filters 1512, such as band-pass filters (BPFs), low-pass filters (LPFs) or other types of filters, to generate RF signals 1515 for subsequent transmission (e.g., by one or more of the antennas 1401 (FIG. 14)) via an example duplexer 1514.

In some dual-mode embodiments for Wi-Fi communication, the FEM circuitry 1404a may be configured to operate in either the 2.4 GHz frequency spectrum or the 5 GHz frequency spectrum. In these embodiments, the receive signal path of the FEM circuitry 1404a may include a receive signal path duplexer 1504 to separate the signals from each spectrum as well as provide a separate LNA 1506 for each spectrum as shown. In these embodiments, the transmit signal path of the FEM circuitry 1404a may also include a power amplifier 1510 and a filter 1512, such as a BPF, an LPF or another type of filter for each frequency spectrum and a transmit signal path duplexer 1504 to provide the signals of one of the different spectrums onto a single transmit path for subsequent transmission by the one or more of the antennas 1401 (FIG. 14). In some embodiments, BT communications may utilize the 2.4 GHz signal paths and may utilize the same FEM circuitry 1404a as the one used for WLAN communications.

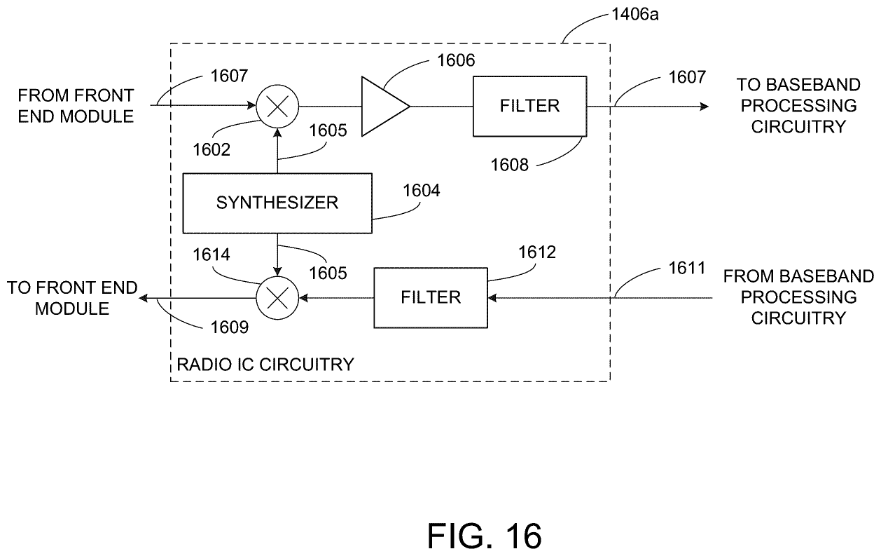

FIG. 16 illustrates radio IC circuitry 1406a in accordance with some embodiments. The radio IC circuitry 1406a is one example of circuitry that may be suitable for use as the WLAN or BT radio IC circuitry 1406a/1406b (FIG. 14), although other circuitry configurations may also be suitable. Alternatively, the example of FIG. 16 may be described in conjunction with the example BT radio IC circuitry 1406b.

In some embodiments, the radio IC circuitry 1406a may include a receive signal path and a transmit signal path. The receive signal path of the radio IC circuitry 1406a may include at least mixer circuitry 1602, such as, for example, down-conversion mixer circuitry, amplifier circuitry 1606 and filter circuitry 1608. The transmit signal path of the radio IC circuitry 1406a may include at least filter circuitry 1612 and mixer circuitry 1614, such as, for example, upconversion mixer circuitry. Radio IC circuitry 1406a may also include synthesizer circuitry 1604 for synthesizing a frequency 1605 for use by the mixer circuitry 1602 and the mixer circuitry 1614. The mixer circuitry 1602 and/or 1614 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 16 illustrates only a simplified version of a radio IC circuitry, and may include, although not shown, embodiments where each of the depicted circuitries may include more than one component. For instance, mixer circuitry 1614 may each include one or more mixers, and filter circuitries 1608 and/or 1612 may each include one or more filters, such as one or more BPFs and/or LPFs according to application needs. For example, when mixer circuitries are of the direct-conversion type, they may each include two or more mixers.

In some embodiments, mixer circuitry 1602 may be configured to down-convert RF signals 1507 received from the FEM circuitry 1404a-b (FIG. 14) based on the synthesized frequency 1605 provided by synthesizer circuitry 1604. The amplifier circuitry 1606 may be configured to amplify the down-converted signals and the filter circuitry 1608 may include an LPF configured to remove unwanted signals from the down-converted signals to generate output baseband signals 1607. Output baseband signals 1607 may be provided to the baseband processing circuitry 1408a-b (FIG. 14) for further processing. In some embodiments, the output baseband signals 1607 may be zero-frequency baseband signals, although this is not a requirement. In some embodiments, mixer circuitry 1602 may comprise passive mixers, although the scope of the embodiments is not limited in this respect.

In some embodiments, the mixer circuitry 1614 may be configured to up-convert input baseband signals 1611 based on the synthesized frequency 1605 provided by the synthesizer circuitry 1604 to generate RF output signals 1509 for the FEM circuitry 1404a-b. The baseband signals 1611 may be provided by the baseband processing circuitry 1408a-b and may be filtered by filter circuitry 1612. The filter circuitry 1612 may include an LPF or a BPF, although the scope of the embodiments is not limited in this respect.

In some embodiments, the mixer circuitry 1602 and the mixer circuitry 1614 may each include two or more mixers and may be arranged for quadrature down-conversion and/or upconversion respectively with the help of synthesizer 1604. In some embodiments, the mixer circuitry 1602 and the mixer circuitry 1614 may each include two or more mixers each configured for image rejection (e.g., Hartley image rejection). In some embodiments, the mixer circuitry 1602 and the mixer circuitry 1614 may be arranged for direct down-conversion and/or direct upconversion, respectively. In some embodiments, the mixer circuitry 1602 and the mixer circuitry 1614 may be configured for super-heterodyne operation, although this is not a requirement.

Mixer circuitry 1602 may comprise, according to one embodiment: quadrature passive mixers (e.g., for the in-phase (I) and quadrature phase (Q) paths). In such an embodiment, RF input signal 1507 from FIG. 16 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1605 of synthesizer 1604 (FIG. 16). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1507 (FIG. 15) may comprise a balanced signal, although the scope of the embodiments is not limited in this respect. The I and Q baseband output signals may be provided to low-noise amplifier, such as amplifier circuitry 1606 (FIG. 16) or to filter circuitry 1608 (FIG. 16).

In some embodiments, the output baseband signals 1607 and the input baseband signals 1611 may be analog baseband signals, although the scope of the embodiments is not limited in this respect. In some alternate embodiments, the output baseband signals 1607 and the input baseband signals 1611 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1604 may be a fractional-N synthesizer or a fractional N/N+1 synthesizer, although the scope of the embodiments is not limited in this respect as other types of frequency synthesizers may be suitable. For example, synthesizer circuitry 1604 may be a delta-sigma synthesizer, a frequency multiplier, or a synthesizer comprising a phase-locked loop with a frequency divider. According to some embodiments, the synthesizer circuitry 1604 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1604 may be provided by a voltage controlled oscillator (VCO), although that is not a requirement. A divider control input may further be provided by either the baseband processing circuitry 1408a-b (FIG. 14) depending on the desired output frequency 1605. In some embodiments, a divider control input (e.g., N) may be determined from a look-up table (e.g., within a Wi-Fi card) based on a channel number and a channel center frequency as determined or indicated by the example application processor 1410. The application processor 1410 may include, or otherwise be connected to, one of the example secure signal converter 101 or the example received signal converter 103 (e.g., depending on which device the example radio architecture is implemented in).

In some embodiments, synthesizer circuitry 1604 may be configured to generate a carrier frequency as the output frequency 1605, while in other embodiments, the output frequency 1605 may be a fraction of the carrier frequency (e.g., one-half the carrier frequency, one-third the carrier frequency). In some embodiments, the output frequency 1605 may be a LO frequency (fLO).

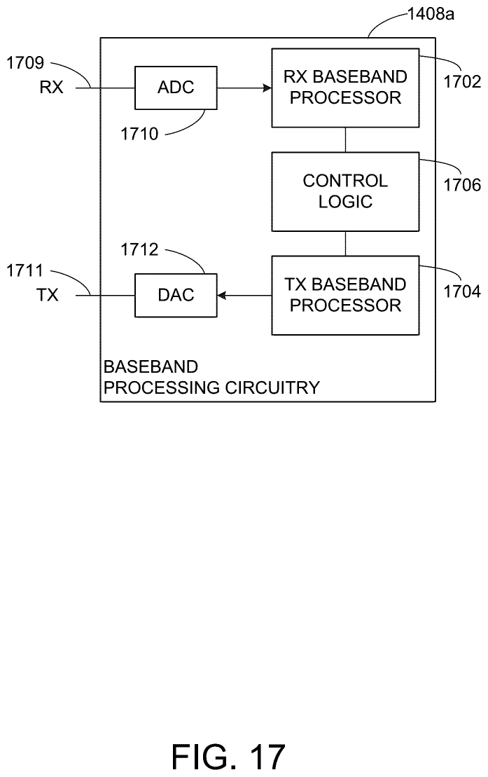

FIG. 17 illustrates a functional block diagram of baseband processing circuitry 1408a in accordance with some embodiments. The baseband processing circuitry 1408a is one example of circuitry that may be suitable for use as the baseband processing circuitry 1408a (FIG. 14), although other circuitry configurations may also be suitable. Alternatively, the example of FIG. 16 may be used to implement the example BT baseband processing circuitry 1408b of FIG. 14.

The baseband processing circuitry 1408a may include a receive baseband processor (RX BBP) 1702 for processing receive baseband signals 1609 provided by the radio IC circuitry 1406a-b (FIG. 14) and a transmit baseband processor (TX BBP) 1704 for generating transmit baseband signals 1611 for the radio IC circuitry 1406a-b. The baseband processing circuitry 1408a may also include control logic 1706 for coordinating the operations of the baseband processing circuitry 1408a.

In some embodiments (e.g., when analog baseband signals are exchanged between the baseband processing circuitry 1408a-b and the radio IC circuitry 1406a-b), the baseband processing circuitry 1408a may include ADC 1710 to convert analog baseband signals 1709 received from the radio IC circuitry 1406a-b to digital baseband signals for processing by the RX BBP 1702. In these embodiments, the baseband processing circuitry 1408a may also include DAC 1712 to convert digital baseband signals from the TX BBP 1704 to analog baseband signals 1711.

In some embodiments that communicate OFDM signals or OFDMA signals, such as through baseband processor 1408a, the transmit baseband processor 1704 may be configured to generate OFDM or OFDMA signals as appropriate for transmission by performing an inverse fast Fourier transform (IFFT). The receive baseband processor 1702 may be configured to process received OFDM signals or OFDMA signals by performing an FFT. In some embodiments, the receive baseband processor 1702 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 14, in some embodiments, the antennas 1401 (FIG. 14) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1401 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: initiate a ranging sequence by transmitting an NDPA frame followed by an I2R NDP frame; receive a corresponding R2I NDP frame and an R2I LMR from a responding station; repeat the ranging sequence for two or more iterations to collect multiple data sets; and process the R2I NDP frame and the R2I LMR to generate continuous ToA and ToD measurements for each iteration.

Example 2 may include the device of example 1 and/or some other example herein, wherein the processing circuitry may be further configured to evaluate the continuity of the ToA and ToD measurements through comparison of adjacent measurements.

Example 3 may include the device of example 1 and/or some other example herein, wherein the processing circuitry may be further configured to: identify a “TOD not continuous” subfield in a “TOD Error field” of the LMR; and set the “TOD not continuous” subfield to 0 to indicate the continuity of the ToD measurements.

Example 4 may include the device of example 1 and/or some other example herein, wherein the processing circuitry may be further configured to perform optional I2R LMR transmission as part of the ranging sequence based on predetermined criteria or configuration settings.

Example 5 may include the device of example 1 and/or some other example herein, wherein the processing circuitry may be further configured to execute algorithms to estimate a kb/ka ratio based on additional measurements and constraints, wherein the kb/ka may be the ratio of clock frequencies or timing offsets of the ISTA and the RSTA.

Example 6 may include the device of example 5 and/or some other example herein, wherein the processing circuitry may be further configured to compare two ToF measurements estimated from repeated measurements for equality.

Example 7 may include the device of example 6 and/or some other example herein, wherein the processing circuitry may be further configured to validate that a duration between two ToD measurements of one device equals the duration between two ToA measurements of the other device.

Example 8 may include the device of example 5 and/or some other example herein, wherein the processing circuitry may be further configured to solve equations formed by observations and constraints to obtain both ToF and the kb/ka ratio.

Example 9 may include the device of example 5 and/or some other example herein, wherein the processing circuitry may be further configured to conduct a double-sided ranging process by exchanging a series of frames between the ISTA and the RSTA to calculate distance based on a ToF with incorporated synchronization adjustments using the kb/ka ratio.

Example 10 may include a non-transitory computer-readable medium storing computer-executable instructions which when executed by one or more processors result in performing operations comprising: initiating a ranging sequence by transmitting an NDPA frame followed by an I2R NDP frame; receiving a corresponding R2I NDP frame and an R2I LMR from a responding station; repeating the ranging sequence for two or more iterations to collect multiple data sets; and processing the R2I NDP frame and the R2I LMR to generate continuous ToA and ToD measurements for each iteration.

Example 11 may include the non-transitory computer-readable medium of example 10 and/or some other example herein, wherein the operations further comprise evaluating the continuity of the ToA and ToD measurements through comparison of adjacent measurements.

Example 12 may include the non-transitory computer-readable medium of example 10 and/or some other example herein, wherein the operations further comprise: identifying a “TOD not continuous” subfield in a “TOD Error field” of the LMR; and setting the “TOD not continuous” subfield to 0 to indicate the continuity of the ToD measurements.

Example 13 may include the non-transitory computer-readable medium of example 10 and/or some other example herein, wherein the operations further comprise performing optional I2R LMR transmission as part of the ranging sequence based on predetermined criteria or configuration settings.

Example 14 may include the non-transitory computer-readable medium of example 10 and/or some other example herein, wherein the operations further comprise executing algorithms to estimate a kb/ka ratio based on additional measurements and constraints, wherein the kb/ka may be the ratio of clock frequencies or timing offsets of the ISTA and the RSTA.

Example 15 may include the non-transitory computer-readable medium of example 14 and/or some other example herein, wherein the operations further comprise comparing two ToF measurements estimated from repeated measurements for equality.

Example 16 may include the non-transitory computer-readable medium of example 15 and/or some other example herein, wherein the operations further comprise validating that a duration between two ToD measurements of one device equals the duration between two ToA measurements of the other device.

Example 17 may include the non-transitory computer-readable medium of example 14 and/or some other example herein, wherein the operations further comprise solving equations formed by observations and constraints to obtain both ToF and the kb/ka ratio.

Example 18 may include the non-transitory computer-readable medium of example 14 and/or some other example herein, wherein the operations further comprise conducting a double-sided ranging process by exchanging a series of frames between the ISTA and the RSTA to calculate distance based on a ToF with incorporated synchronization adjustments using the kb/ka ratio.

Example 19 may include a method comprising: initiating a ranging sequence by transmitting an NDPA frame followed by an I2R NDP frame; receiving a corresponding R2I NDP frame and an R2I LMR from a responding station; repeating the ranging sequence for two or more iterations to collect multiple data sets; and processing the R2I NDP frame and the R2I LMR to generate continuous ToA and ToD measurements for each iteration.

Example 20 may include the method of example 19 and/or some other example herein, further comprising evaluating the continuity of the ToA and ToD measurements through comparison of adjacent measurements.

Example 21 may include the method of example 19 and/or some other example herein, further comprising: identifying a “TOD not continuous” subfield in a “TOD Error field” of the LMR; and setting the “TOD not continuous” subfield to 0 to indicate the continuity of the ToD measurements.

Example 22 may include the method of example 19 and/or some other example herein, further comprising performing optional I2R LMR transmission as part of the ranging sequence based on predetermined criteria or configuration settings.

Example 23 may include the method of example 19 and/or some other example herein, further comprising executing algorithms to estimate a kb/ka ratio based on additional measurements and constraints, wherein the kb/ka may be the ratio of clock frequencies or timing offsets of the ISTA and the RSTA.

Example 24 may include the method of example 23 and/or some other example herein, further comprising comparing two ToF measurements estimated from repeated measurements for equality.

Example 25 may include the method of example 24 and/or some other example herein, further comprising validating that a duration between two ToD measurements of one device equals the duration between two ToA measurements of the other device.

Example 26 may include the method of example 23 and/or some other example herein, further comprising solving equations formed by observations and constraints to obtain both ToF and the kb/ka ratio.

Example 27 may include the method of example 23 and/or some other example herein, further comprising conducting a double-sided ranging process by exchanging a series of frames between the ISTA and the RSTA to calculate distance based on a ToF with incorporated synchronization adjustments using the kb/ka ratio.

Example 28 may include an apparatus comprising means for: initiating a ranging sequence by transmitting an NDPA frame followed by an I2R NDP frame; receiving a corresponding R2I NDP frame and an R2I LMR from a responding station; repeating the ranging sequence for two or more iterations to collect multiple data sets; and processing the R2I NDP frame and the R2I LMR to generate continuous ToA and ToD measurements for each iteration.

Example 29 may include the apparatus of example 28 and/or some other example herein, further comprising evaluating the continuity of the ToA and ToD measurements through comparison of adjacent measurements.

Example 30 may include the apparatus of example 28 and/or some other example herein, further comprising: identifying a “TOD not continuous” subfield in a “TOD Error field” of the LMR; and setting the “TOD not continuous” subfield to 0 to indicate the continuity of the ToD measurements.

Example 31 may include the apparatus of example 28 and/or some other example herein, further comprising performing optional I2R LMR transmission as part of the ranging sequence based on predetermined criteria or configuration settings.

Example 32 may include the apparatus of example 28 and/or some other example herein, further comprising executing algorithms to estimate a kb/ka ratio based on additional measurements and constraints, wherein the kb/ka may be the ratio of clock frequencies or timing offsets of the ISTA and the RSTA.

Example 33 may include the apparatus of example 32 and/or some other example herein, further comprising comparing two ToF measurements estimated from repeated measurements for equality.

Example 34 may include the apparatus of example 33 and/or some other example herein, further comprising validating that a duration between two ToD measurements of one device equals the duration between two ToA measurements of the other device.

Example 35 may include the apparatus of example 32 and/or some other example herein, further comprising solving equations formed by observations and constraints to obtain both ToF and the kb/ka ratio.

Example 36 may include the apparatus of example 32 and/or some other example herein, further comprising conducting a double-sided ranging process by exchanging a series of frames between the ISTA and the RSTA to calculate distance based on a ToF with incorporated synchronization adjustments using the kb/ka ratio.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Example 41 may include a method of communicating in a wireless network as shown and described herein.

Example 42 may include a system for providing wireless communication as shown and described herein.

Example 43 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device of an initiating station device (ISTA), the device comprising processing circuitry coupled to storage, the processing circuitry configured to:
initiate a ranging sequence by transmitting a null data packet announcement (NDPA) frame to a responding station device (RSTA) followed by an initiator-to-responder (I2R) null data packet (NDP) frame;
receive a corresponding responder-to-initiator (R2I) NDP frame and an R2I location measurement report (LMR) from a responding station;
repeat the ranging sequence for two or more iterations to collect multiple data sets; and
process the R2I NDP frame and the R2I LMR to generate continuous time of arrival (ToA) and time of departure (ToD) measurements for each iteration.

2. The device of claim 1, wherein the processing circuitry is further configured to evaluate the continuity of the ToA and ToD measurements through comparison of adjacent measurements.

3. The device of claim 1, wherein the processing circuitry is further configured to:
identify a “TOD not continuous” subfield in a “TOD Error field” of the LMR; and
set the “TOD not continuous” subfield to 0 to indicate the continuity of the ToD measurements.

4. The device of claim 1, wherein the processing circuitry is further configured to perform optional I2R LMR transmission as part of the ranging sequence based on predetermined criteria or configuration settings.

5. The device of claim 1, wherein the processing circuitry is further configured to execute algorithms to estimate a k_{b}/kₐ ratio based on additional measurements and constraints, wherein the k_{b}/kₐ is the ratio of clock frequencies or timing offsets of the ISTA and the RSTA.

6. The device of claim 5, wherein the processing circuitry is further configured to compare two ToF measurements estimated from repeated measurements for equality.

7. The device of claim 6, wherein the processing circuitry is further configured to validate that a duration between two ToD measurements of one device equals the duration between two ToA measurements of the other device.

8. The device of claim 5, wherein the processing circuitry is further configured to solve equations formed by observations and constraints to obtain both ToF and the k_{b}/kₐ ratio.

9. The device of claim 5, wherein the processing circuitry is further configured to conduct a double-sided ranging process by exchanging a series of frames between the ISTA and the RSTA to calculate distance based on a ToF with incorporated synchronization adjustments using the k_{b}/kₐ ratio.

10. A non-transitory computer-readable medium storing computer-executable instructions which when executed by one or more processors of an initiating station device (ISTA) result in performing operations comprising:
initiating a ranging sequence by transmitting a null data packet announcement (NDPA) frame a responding station device (RSTA) followed by an initiator-to-responder (I2R) null data packet (NDP) frame;
receiving a corresponding responder-to-initiator (R2I) NDP frame and an R2I location measurement report (LMR) from a responding station;
repeating the ranging sequence for two or more iterations to collect multiple data sets; and
processing the R2I NDP frame and the R2I LMR to generate continuous time of arrival (ToA) and time of departure (ToD) measurements for each iteration.

11. The non-transitory computer-readable medium of claim 10, wherein the operations further comprise evaluating the continuity of the ToA and ToD measurements through comparison of adjacent measurements.

12. The non-transitory computer-readable medium of claim 10, wherein the operations further comprise:
identifying a “TOD not continuous” subfield in a “TOD Error field” of the LMR; and
setting the “TOD not continuous” subfield to 0 to indicate the continuity of the ToD measurements.

13. The non-transitory computer-readable medium of claim 10, wherein the operations further comprise performing optional I2R LMR transmission as part of the ranging sequence based on predetermined criteria or configuration settings.

14. The non-transitory computer-readable medium of claim 10, wherein the operations further comprise executing algorithms to estimate a k_{b}/kₐ ratio based on additional measurements and constraints, wherein the k_{b}/kₐ is the ratio of clock frequencies or timing offsets of the ISTA and the RSTA.

15. The non-transitory computer-readable medium of claim 14, wherein the operations further comprise comparing two ToF measurements estimated from repeated measurements for equality.

16. The non-transitory computer-readable medium of claim 15, wherein the operations further comprise validating that a duration between two ToD measurements of one device equals the duration between two ToA measurements of the other device.

17. The non-transitory computer-readable medium of claim 14, wherein the operations further comprise solving equations formed by observations and constraints to obtain both ToF and the k_{b}/kₐ ratio.

18. The non-transitory computer-readable medium of claim 14, wherein the operations further comprise conducting a double-sided ranging process by exchanging a series of frames between the ISTA and the RSTA to calculate distance based on a ToF with incorporated synchronization adjustments using the k_{b}/kₐ ratio.

19. A method comprising:
initiating, by one or more processors of an initiating station device (ISTA), a ranging sequence by transmitting a null data packet announcement (NDPA) frame a responding station device (RSTA) followed by an initiator-to-responder (I2R) null data packet (NDP) frame;
receiving a corresponding responder-to-initiator (R2I) NDP frame and an R2I location measurement report (LMR) from a responding station;
repeating the ranging sequence for two or more iterations to collect multiple data sets; and
processing the R2I NDP frame and the R2I LMR to generate continuous time of arrival (ToA) and time of departure (ToD) measurements for each iteration.

20. The method of claim 19, further comprising evaluating the continuity of the ToA and ToD measurements through comparison of adjacent measurements.
